(19) United States
(12) Patent Application Publication
(10) Pub. No.: US 2011/0264418 A1
(43) Pub. Date: Oct. 27, 2011

(54) DETERMINING ELECTRICAL CONSUMPTION IN A FACILITY

(75) Inventors: Robert Szewczyk, Castro Valley, CA (US); Courtney Sharp, San Francisco, CA (US); Joseph Polastre, San Francisco, CA (US); Christophe Merlin, San Mateo, CA (US)

(73) Assignee: SENTILLA CORPORATION, INC., Redwood City, CA (US)

(21) Appl. No.: 12/764,881

(22) Filed: Apr. 21, 2010

(51) Int. Cl. G06F 17/10

(52) U.S. Cl. 703/2; 702/61

(57) ABSTRACT

A system and a method are disclosed for determining the electrical values of assets in a facility. The system receives a power tree configuration for a facility. The system generates a mathematical model of the power tree configuration. The mathematical model includes nodes that represent assets of the power tree configuration. The system receives electrical values for an asset and associates the values with a node. The system receives electrical values for another asset and associates the values with another node. The system then determines the electrical values for a different node based on the electrical values associated with the first two nodes.

### BACKGROUND

1. Field of Art

The disclosure generally relates to energy management solutions, specifically to an energy management solution for determining electrical consumption in a facility.

2. Description of the Related Art

Energy management solutions aim to understand energy consumption in a facility by analyzing where the energy goes and whether it produces useful work. Every facility includes a power distribution tree, which is the network of electrical circuits that take power from the utility company and distribute power to each asset within the facility. Energy management solutions analyze electrical data from the power distribution tree in order to extract recommendations for facility managers, generate reports such as a power bill, or perform diagnostics to identify areas of risk.

Asset metering is an integral part of conventional energy management solutions. In order to generate an accurate analysis of a power distribution tree, the electrical consumption of each asset must be known. Conventional energy management solutions acquire electrical measurements by monitoring the electrical consumption of each asset with a physical hardware meter. However, in many facilities there can be thousands of assets, each of which must be monitored with a separate physical meter. The cost of purchasing and installing thousands of physical meters can be prohibitively expensive.

The installation of physical meters also requires assets to be disconnected from the power distribution tree for a period of time while the meters are installed. However, many facilities, such as data centers, are expected to operate without any downtime, 24 hours a day, 7 days a week. Thus, facility managers cannot accept the service disruption needed to install physical meters.

Hence, there is lacking an energy management solution that can accurately assess the energy consumption of a facility without the need for installing physical meters on every asset.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of components of an example machine able to read instructions from a machine-readable medium and execute them in a processor (or controller).

FIG. 2 is a high level overview of one embodiment of a system for determining the electrical values of assets in a facility.

FIG. 3 illustrates one embodiment of a flowchart of a virtual meter for determining electrical values.

FIG. 4 illustrates one embodiment of a power consumption model for a computer server.

FIG. 5 illustrates one embodiment of a power tree configuration of a facility.

FIG. 6 illustrates one embodiment of a high-level block diagram of a power tree analysis module.

FIG. 7 illustrates one embodiment of a flowchart for determining electrical values from a power tree configuration.

FIG. 8 illustrates one embodiment of a mathematical model generated from the power tree configuration of FIG. 5.

FIG. 9 illustrates one embodiment of a mathematical model with associated electrical values.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

CONFIGURATION OVERVIEW

One embodiment of a disclosed system, method and computer readable storage medium that includes determining electrical values of assets in a facility.

One aspect provides a computer-implemented method for determining the electrical values of assets in a facility. A power tree configuration for a facility is received. A mathematical model of the power tree configuration is generated. The model comprises nodes that represent assets of the power tree configuration. Electrical values are received for an asset and associated with a node. Electrical values are received for another asset and associated with another node. Electrical values are determined for a third node based on the electrical value associated with the first two nodes.

In another aspect, the described embodiments provide a computer system for determining the electrical values of assets in a facility. The system comprises a power tree input module configured to receive a power tree configuration of the facility. The system comprises a conversion module configured to generate a mathematical model from the power tree configuration. The model comprises nodes that represent assets of the power tree configuration. The system comprises an electrical value input module configured to receive electrical values for an asset and to associate the electrical values with a node in the model. The electrical value input module is further configured to receive electrical values for another asset and to associate the electrical values with another node in the model. The system further comprises an analysis module configured to determine electrical values for a third node based on the electrical values associated with the first two nodes.

Another aspect is embodied as a computer-readable storage medium storing instructions for determining the electrical values of assets in a facility according to the above described method.

Another aspect is a computer-implemented method for determining electrical values for an asset from dynamic and static information. Dynamic information representing the work done by or utilization of an asset is received. Static information identifying the asset, the components of the asset, or electrical properties of the asset is received. Based on the static information, a power consumption model is automatically selected for the asset. Electrical values are then determined based on the dynamic information and the power consumption model.

COMPUTING MACHINE ARCHITECTURE

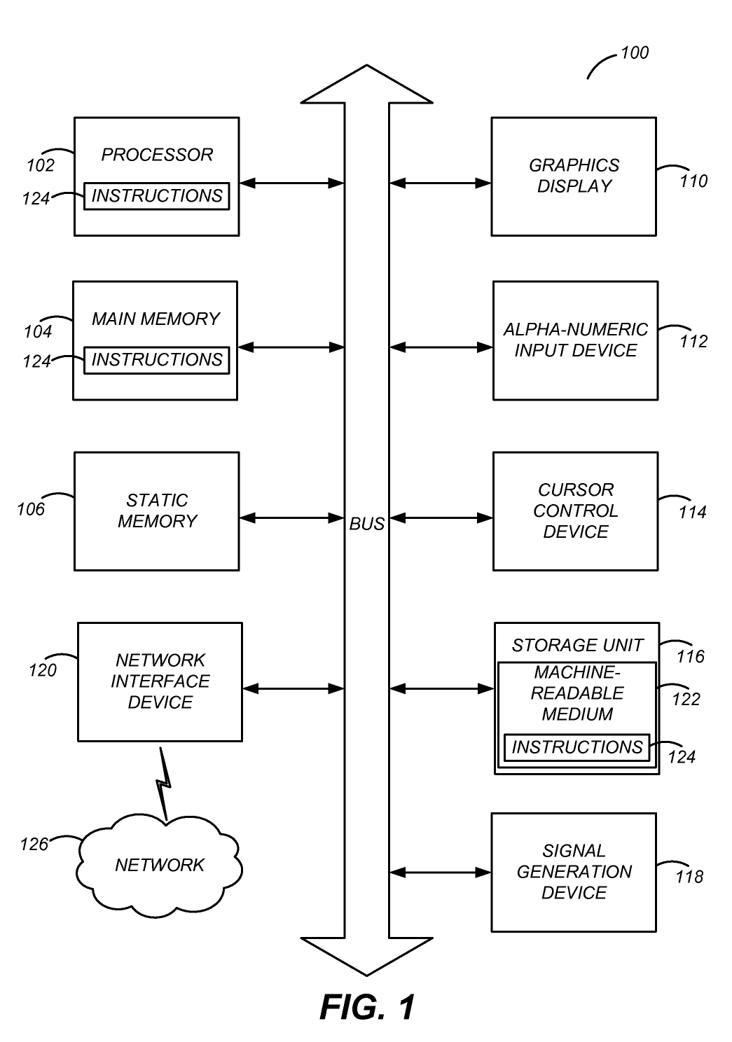

FIG. 1 is a block diagram illustrating components of an example machine able to read instructions from a machine-readable medium and execute them in a processor (or controller). Specifically, FIG. 1 shows a diagrammatic representation of a machine in the example form of a computer system 100 within which instructions 124 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 124 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 100 includes a processor 102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 104, and a static memory 106, which are configured to communicate with each other via a bus 108. The computer system 100 may further include graphics display unit 110 (e.g., a plasma display panel (PDP), a liquid crystal display (LCD), a projector, or a cathode ray tube (CRT)). The computer system 100 may also include alphanumeric input device 112 (e.g., a keyboard), a cursor control device 114 (e.g., a mouse, a trackball, a joystick, a motion sensor, or other pointing instrument), a storage unit 116, a signal generation device 118 (e.g., a speaker), and a network interface device 820, which also are configured to communicate via the bus 108.

The storage unit 116 includes a machine-readable medium 122 on which is stored instructions 124 (e.g., software) embodying any one or more of the methodologies or functions described herein. The instructions 124 (e.g., software) may also reside, completely or at least partially, within the main memory 104 or within the processor 102 (e.g., within a processor's cache memory) during execution thereof by the computer system 100, the main memory 104 and the processor 102 also constituting machine-readable media. The instructions 124 (e.g., software) may be transmitted or received over a network 126 via the network interface device 120.

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but not be limited to, data repositories in the form of solid-state memories, optical media, and magnetic media.

In one embodiment, the processes described herein are configured as modules storable and executable within a computer system, for example, the computer system 100. The modules may include instructions 124 that are stored within the storage unit 116, for example, in a machine readable medium 122. The instructions 124 are executable through processor 102.

SYSTEM ARCHITECTURE

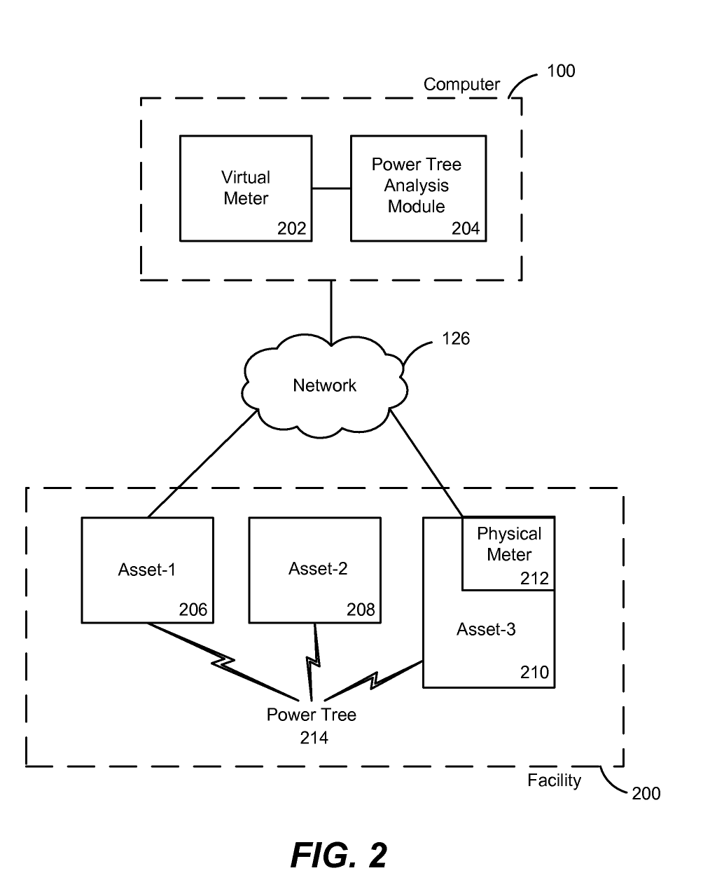

FIG. 2 is a high level overview of one embodiment of a system for determining the electrical values of assets in a facility. FIG. 2 illustrates a facility 200 containing a power distribution tree 214. A facility is a predefined space, e.g., a campus, a building, a data center. Asset-1 206, asset-2 208, and asset-3 210 are assets connected by a power distribution tree 214 of facility 200. An asset is a physical structure that couples with a power distribution tree and either produces power for the tree or draws power from the tree. The asset may be a piece of electrical equipment, e.g., a server computer, heating ventilation and air conditioning (HVAC) unit, networking equipment, power distribution unit, switching unit, televisions, display screens, appliances. An asset may also be an electrical component, e.g., a central processing unit (CPU), hard drive, memory, power supply, motor.

The computer 100 is connected to the asset-1 206 and the asset-3 210 through network 126. A virtual meter 202 and a power tree analysis module 204 are stored in the memory of computer 100. The virtual meter 202 and power tree analysis module 204 are configured to receive information from the computer 100 and to communicate with each other in order to determine electrical values for assets in the facility 200. Electrical values include parameters corresponding to electrical draw from a power distribution tree, for example, voltage, amperage, real power, apparent power, and energy.

The computer 100 interacts with the asset-1 206 via the network 126. In one embodiment, the computer 100 receives dynamic information corresponding to the work done by the asset-1 206, e.g. a utilization rate. The computer also receives static information identifying the asset-1 206, e.g. a model number. Based on this information, the virtual meter 202 determines the electrical values associated with the asset-1 206.

The computer 100 further interacts with the asset-3 210 via the network 126. In one embodiment, the asset-3 210 includes an embedded physical hardware meter 212 which measures the electrical values associated with the asset-3 210. A physical hardware meter is a device that directly measures electrical values, e.g., a multimeter, current transducer, hall effect sensor, shunt, inline wattmeter, power plug meter. The computer 100 receives the electrical value measurements from the physical meter 212 through the asset-3 210. The electrical value measurements for the asset-3 210 and the electrical values for the assset-1 206 are input into the power tree analysis module 204. Based on this information, the power tree analysis module 204 determines the electrical values for asset-2 208.

It should be noted that only three assets are shown in FIG. 2 in order to simplify the figure. Embodiments of the facility can have thousands of assets which are connected to the network 126. In another embodiment, all the parts of FIG. 2 may be located within the facility 200. For example, the computer 100 may be connected to the power distribution tree 214 and placed inside of the facility 200. In a further embodiment, the assets may be connected directly to the computer 200 instead of through the network 126.

The combination of the virtual meter 202 and the power tree analysis module 204 thus allows the computer 100 to analyze the power consumption of the facility 200 without the need to install physical hardware meters on every asset coupled to the power distribution tree of the facility. The following two sections explain the detailed operations of the virtual meter 202 and the power tree analysis module 204.

VIRTUAL METER CONFIGURATION

FIGS. 2 through 4 illustrate one embodiment of a virtual meter 202 for determining the electrical consumption of an asset. The virtual meter 202 is configured to provide information about the electrical values of an asset. The information is derived by obtaining data corresponding to the work performed by or utilization of the asset. Configuring and implementing a virtual meter 202 reduces the need to install physical meters on every asset coupled with the power distribution tree.

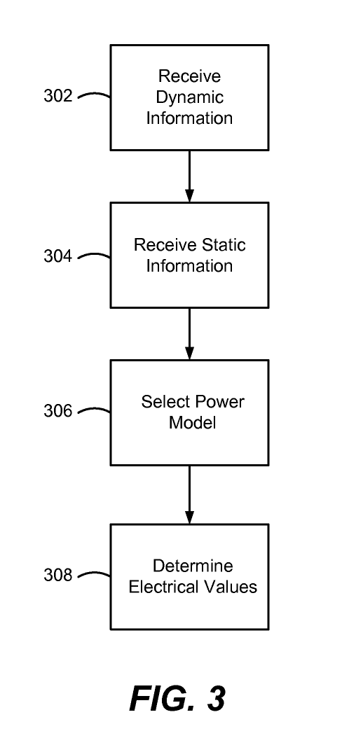

FIG. 3 illustrates a flowchart of one embodiment of a process of a virtual meter for determining electrical values. The virtual meter 202 determines electrical values for an asset by receiving 302 dynamic information associated with the asset, receiving 304 static information associated with the asset, selecting 306 a power consumption model based on the static information, and determining 308 electrical values for the asset based on the dynamic information and the power consumption model.

Dynamic information corresponds to the work done by or the utilization of an asset. Dynamic information typically changes over time as the usage of the asset changes. For example, if the asset is a central processing unit (CPU), the dynamic information associated with the CPU could be the processor utilization. Other examples of dynamic information are disk drive utilization, memory utilization, amount of data passing through a piece of equipment, amount of cooling and airflow provided by a HVAC, the on/off status of a light switch, etc. The virtual meter may receive more than one type of dynamic information for a single asset. For example, if the asset is a computer server, the dynamic information associated with the server could be both the processor utilization rate and the disk drive utilization.

The virtual meter 202 can receive 302 dynamic information from a variety of sources. Dynamic information can be transmitted by the asset itself. For example, for servers, storage devices, and network devices, dynamic information can be obtained from software applications that are installed on the assets. Software applications include network and system management (NMS) agents. Exemplary NMS agents include commercially available products such as GANGLIA, NAGIOS, CACTI, TIVOLI, and OPENVIEW. The virtual meter 202 receives information from the NMS agents by listening to transmissions, periodically polling the agents, or periodically polling the utilization database of the agents. Alternatively, dynamic information may not be transmitted directly from the asset. For example, for cooling units and lights, the virtual meter 202 can receive temperature, humidity, air velocity, and switch state information from building management systems (BMS) solutions. Dynamic information can also be received from sensors that are configured to measure the dynamic information of an asset. Varying data formats from each source of information can also be translated into a common format for ease of use.

Static information identifies the asset, components of the asset, or properties associated with the asset. For example, if the asset is a CPU, the static information could be the model number of the CPU. Other examples of static information include the asset type, the configuration of the asset, the electrical specifications of the asset, the nominal power consumption, serial number, manufacturer, internet protocol (IP) address, media access control (MAC) address etc. The virtual meter 202 may receive more than one type of static information for a single asset. For example, if the asset is a multi-CPU computer server, the static information associated with the server could be both the model number of the CPUs and the number of CPUs installed in the server.

The virtual meter 202 can receive 304 static information from a variety of sources. Static information may be transmitted by the asset itself, such as from a software application installed on an asset. For example, an NMS agent may tell the virtual meter that it is sending utilization data for a “60 GB hard drive.” A diagnostic script may be installed on the target asset to collect and transmit static information to the virtual meter. This static information may be stored in the virtual meter so that it does not need to be retrieved from the asset a second time. Alternatively, static information may not be received directly from the asset. For example, the static information may be entered by a user when configuring the virtual meter. When configuring the virtual meter, the user may enter “60 Watt light bulb” as an asset and associate the asset with a particular light switch monitor.

The virtual meter 202 selects 306 a power consumption model based on the static information for the asset. A power consumption model represents the relationship between the dynamic information, or utilization of an asset, and the electricity consumed by the asset. In one embodiment, a power model has a fixed component and a variable component. The fixed component accounts for the power consumed by the asset when it is idle. The variable component accounts for the power consumed by the asset as the utilization changes. For assets that generate only one type of dynamic information, the power consumption model can generally be illustrated by the following formula:

P=C+F(util)

wherein P represents the electricity consumed by the asset. C represents the fixed electrical consumption of the asset. F(util) represents the variable electrical consumption of the asset. Util represents the utilization of the asset.

In one embodiment, the aforementioned power consumption model is a linear model. A linear model is represented by the following formula:

P=C0+C1*(util)

wherein P represents the electricity consumed by the asset. C0 represents the fixed electrical consumption of the asset. C1*(util) represents the variable electrical consumption of the asset. C1 is the power consumption at full utilization minus the power consumption at idle. Util represents the utilization of the asset.

In one embodiment, the power consumption model for an asset is a non-linear model. A non-linear model is represented by the following formula:

P=C0+C1*(util)+C2*(util)̂2+ . . . CR*(util)̂R

wherein P represents the electricity consumed by the asset. C0 represents the fixed electrical consumption of the asset. The remainder of the formula represents the variable electrical consumption of the asset. C1, C2, and CR are constants that are pre-determined to produce an accurate power estimate based on the utilization of the asset. Util represents the utilization of the asset. In one embodiment, a non-linear model may have the advantage of being more accurate than a linear model.

It is noted that each asset consumes electricity differently. Even if the virtual meter exclusively applies a linear model to estimate the power consumption for all assets, the power model for each asset may still be different because each model may have a different set of constants. In one embodiment, the power model for an asset contains constants that are appropriate for that particular asset. For example, if an asset is identified as a CPU, the virtual meter will select a model with values for C0 and C1 that are appropriate for a CPU.

In one embodiment, power models can range from being generic to a category of products to being specific to a particular type of product. For example, there may be a generic model for “INTEL processors” with one set of constants. There may be a more specific model for “INTEL XEON processors” with another set of constants. Or there may be an even more specific model for “INTEL XEON W5590 130 Watt processors” with a different set of constants. Using a model that is specific to a particular asset will generate more accurate estimates than using a generic model. If a model does not exist for a particular asset, the virtual meter may select a model associated with a closely related asset instead. For example, if a CPU is made by Advanced Micro Devices (AMD), but a model for an AMD processor does not exist, the virtual meter may use the model for an Intel Processor instead.

In one embodiment, the power model for an asset is based on the power models of the individual components of an asset. Assets that are comprised of several components may generate multiple types of dynamic information. For example, a computer server can output both CPU and hard drive utilization data. For an asset that generates multiple types of dynamic information, the power consumption for the asset is the algebraic sum of the power consumption for each of its individual components. In one embodiment, the power model can be represented by the following formula:

P=P1+P2+ . . . PN

wherein P represents the electrical consumption of the asset. P1, P2, and PN represent the power models associated with the various components of the asset.

It is noted that the aforementioned power model can be represented as having a fixed electrical consumption component and a variable electrical consumption component. For example, the aforementioned power model can be represented by the following formula

P=C1+C2+ . . . CN+F1(util1)+F2(util2)+ . . . FN(utilN)

wherein P represents the electrical consumption of the asset. C1+C2+CN represent the aggregate fixed power consumption of the entire asset based on the fixed power consumption of its individual components. These individual constants can be combined and represented as single constant. F1(util1)+F2(util2)+FN(utilN) represent the aggregate variable power consumption of the asset based on the variable power consumption of its individual components.

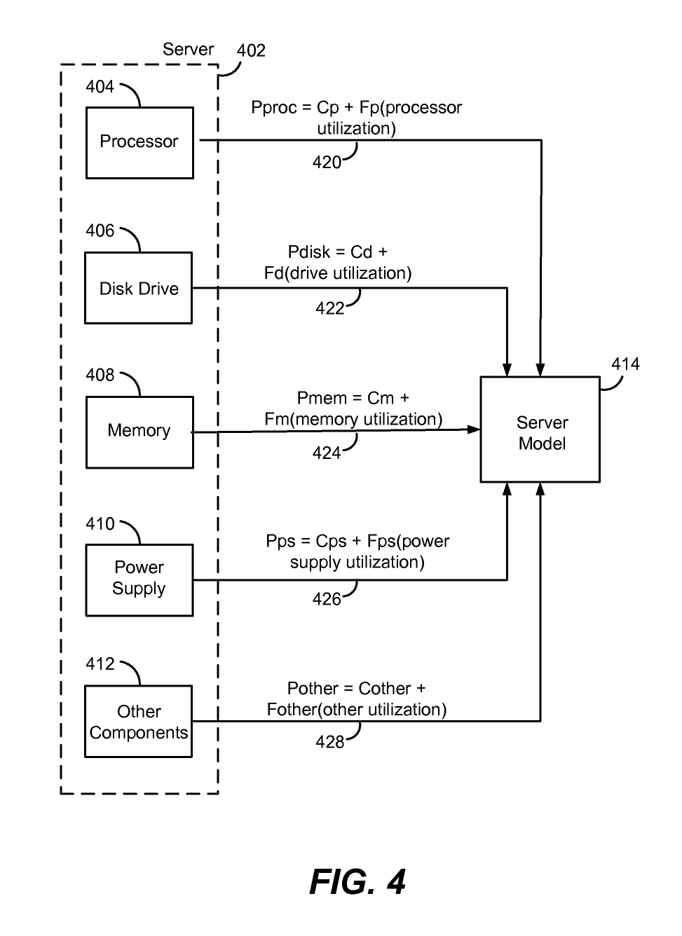

To illustrate, FIG. 4 is an example embodiment of a power consumption model for a computer server. The computer server 402 is an asset that includes the following components: a processor 404, a disk drive 406, a memory 408, and a power supply 410. The server also includes other components 412 which are combined together for ease of explanation. By way of example, other components 412 can include fans, motherboards, and network cards. Pproc 420, Pdisk 422, Pmem 424, and Pps 426, and Pother 428 represent the power consumption models for the processor 404, disk drive 406, memory 408, power supply 410, and other components 412 respectively. The server model 414 is the power consumption model for server 402 that is generated from the individual models. The lines in FIG. 4 that connect the components of the server 402 and the power consumption model 414 are not physical connections, but simply represent the relative power consumption associated with each component of the server.

To determine the power consumption of the server 402, the virtual meter 202 generates a power consumption model 414 that is based on the models of its individual components. Specifically, the virtual meter 202 associates a power consumption model with various components of the server 402. A separate power model is associated with each of processor 404, disk drive 406, memory 408, power supply 410, and other components 412. A server model 414 is created by summing together the models for the individual components of the server 402. Thus, the server model 414 is equal to Pproc 420+Pdisk 422+Pmem 424+Pps 426+Pother 428.

It is noted that in one embodiment, if a power model does not exist for a component, the component's average power consumption can be substituted for the model. Alternatively, the component can be completely ignored. These alternative approaches will reduce the accuracy of the overall model, but allow a model to be constructed even if some information is missing.

In one embodiment, the power models may be obtained from any of a variety of sources. For example, the manufacturer of an asset may provide the model. A third-party may perform power measurements in order to determine the model for an asset and provide that model to the virtual meter. The model may be based on a manufacturer's electrical specifications for their product. Furthermore, the model may be pre-loaded into the virtual meter 202 or downloaded in real-time when needed.

In one embodiment, multiple power consumption models are pre-loaded into the virtual meter 202. The virtual meter 202 can automatically select an appropriate power model based on the static information. For example, there may be a power consumption model for a HP DL380 G6 server. There may be a separate power consumption model for a DELL POWEREDGE R810 server. If the virtual meter 202 identifies an asset as a HP DL380 G6 server, it will select the model for the HP DL380 G6 server to estimate electrical values. Alternatively, if the asset type is unknown or there is no model for a particular asset, the virtual meter 202 can generate a model for the asset in real-time based on the individual components of the asset. For example, if the virtual meter 202 knows that a server contains a 30 GB hard drive and an Intel processor, it can generate a server model using the power models for a 30 GB hard drive and an Intel processor. Alternatively, the virtual meter 202 may select a pre-existing model which most closely resembles the asset being monitored. In one embodiment, the virtual meter further associates the power model with the asset so that the power model only needs to be selected the first time that static information is received.

It should be noted that the method of generating a power consumption model illustrated in FIG. 3 is not limited to servers. A power consumption model can be generated for any asset for which the utilization of the asset can be measured. For example, a power consumption model can be generated for laptop or desktop computers, printers, scanners, fax machines, recharging stations, networking equipment, televisions or display screens, appliances, motors, etc.

The following examples illustrate the operation of the virtual meter 202 with respect to different assets. In one embodiment, the virtual meter 202 determines the electrical consumption of a heating ventilation and air conditioning (HVAC) unit. A HVAC can contain components such as a compressor and a fan. The virtual meter 202 receives dynamic information associated with the HVAC, such as the change in temperature imparted on the air passing through the HVAC and the velocity of air passing through the unit. This dynamic information can be captured by sensors attached to the HVAC. The virtual meter 202 receives static information associated with the HVAC, such as the type and configuration of the HVAC. A power model is selected for the HVAC. The virtual meter 202 then estimates the electrical values of the HVAC based on this information.

In one embodiment, the virtual meter 202 estimates the electrical consumption of a storage device. The virtual meter 202 receives dynamic information associated with the storage device, such as the number of bytes written to and read from the storage unit. The virtual meter receives static information associated with the storage device, such as the type and configuration of the storage unit. A power model is selected for the storage device. The virtual meter 202 then estimates the electrical values of the storage unit based on this information.

In one embodiment, the virtual meter 202 determines the electrical consumption of networking equipment, for example, switches and routers. The virtual meter 202 receives dynamic information associated with the networking equipment, such as the number of data packets passing through the equipment and the internal computing utilization of the switch. The virtual meter 202 receives static information associated with the equipment, such as the type and configuration of the equipment. A power model is selected for the networking equipment. The virtual meter 202 then determines the electrical values of the equipment based on this information.

In one embodiment, the virtual meter 202 determines the electrical consumption loss of Power Distribution Units (PDU). PDUs are assets which receive electricity and distribute it to other electrical assets. PDUs are not 100% efficient and will consume electricity due to their own internal components. To determine the electrical consumption loss of the PDU, the virtual meter 202 receives dynamic information associated with the PDU, such as the amount of electricity flowing into the PDU. The virtual meter 202 identifies static information associated with the PDU, such as the type and configuration of the PDU. A power model is selected for the PDU. The virtual meter then determines the electrical values of the PDU based on this information.

In one embodiment, the virtual meter 202 determines the electrical consumption of lights. The virtual meter 202 receives dynamic information associated with the lights by monitoring on/off switches and light sensors if they are available. The virtual meter 202 identifies static information such as the type and wattage of the light bulbs. A power model is selected for the lights. The virtual meter 202 then determines the electrical values of the lights based on this information.

Further, the reverse of the virtual meter 202 is possible, meaning that asset utilization can be determined based on the electrical consumption of the asset. For example, the utilization of a processor in a server can be determined from the power consumption of the server by following the reverse of the described process. Knowing the power consumption, the system subtracts any known constants then allocates the remaining power to the subcomponents. Since the processor utilization has been found to cause the most variance in power consumption, the virtual meter can determine the processor utilization of the server.

As illustrated by the preceding discussion, the virtual meter 202 determines the electrical values of an asset based in part on dynamic and static information associated with the asset. The disclosed embodiments beneficially allow for measuring electrical values without the need for any physical meters. The electrical values determined by the virtual meter can further be used as an input to a power tree analysis module 204, which will be discussed in the following section.

POWER TREE ANALYSIS CONFIGURATION

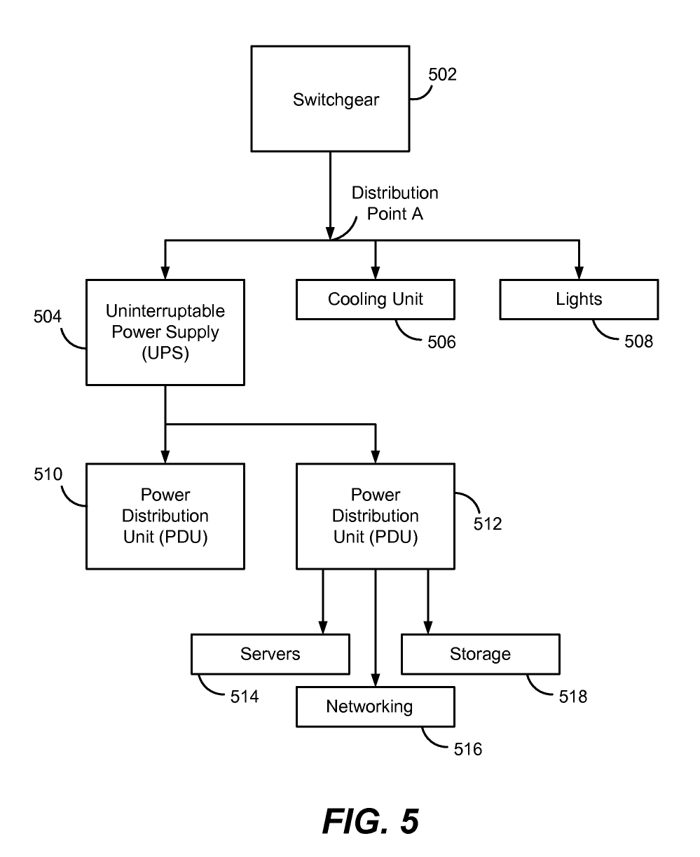

FIGS. 5-9 illustrate the operations of a power tree analysis module 204 for determining electrical values. Initially, reference is made to a structure of a power distribution tree and how electrical values can be inferred from the structure of the power distribution tree. In general, all electrical assets in a facility are connected to a power distribution tree within the facility. Electricity enters the power tree through a single point, which is then divided and distributed to the branches of the tree. Electricity may be consumed by assets located at the ends of the branches, or it may be consumed by assets that distribute power into those branches.

Turning now to FIG. 5, it illustrates one embodiment of a power tree configuration of electrical assets in a facility such as a data center. Specifically, electricity flows into the tree at the switchgear 502. Electricity flows downstream to distribution point A, where it is distributed to the lights 508, cooling unit 506, and uninterruptable power supply (UPS) 504. Electricity flowing into the UPS 504 is further distributed to power distribution unit (PDU) 510 and PDU 512. Electricity flowing into PDU 512 is further distributed to servers 514, networking 516, and storage 518 where it is consumed by these devices. Note that UPS 504 and PDU 512 may themselves consume electricity even though they are not located at the outer reaches of the power tree.

The flow of electricity in the power tree is principally similar to other flow configurations. An inbound flow equals a flow internally within the system. In the configuration as described, the electricity entering any distribution point is equal to the electricity leaving that distribution point. If the system knows the electrical values on some branches in the power tree, the system can infer the electrical values on the other branches. For example, by knowing the amount of electricity entering UPS 504, cooling unit 506, and lights 508, it is possible to infer the total amount of electricity flowing out of switchgear 502.

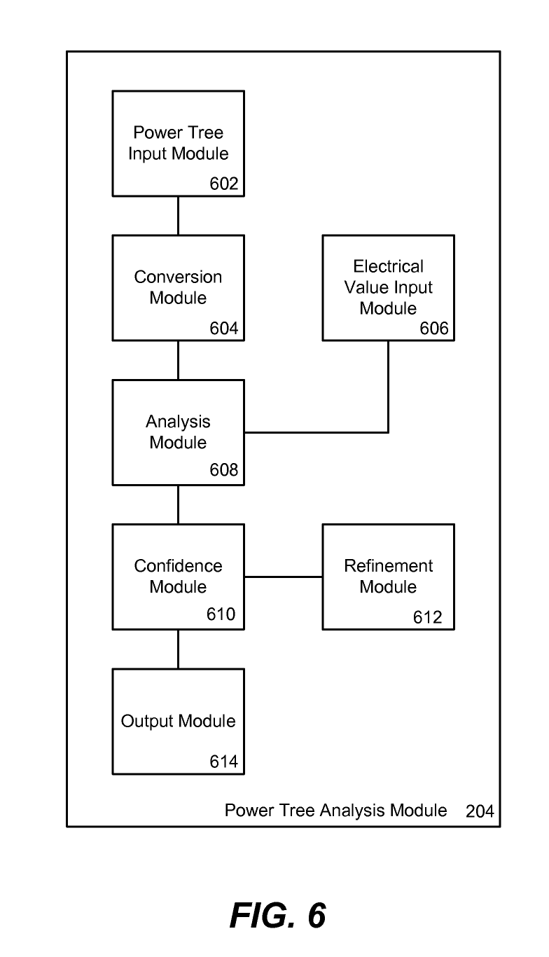

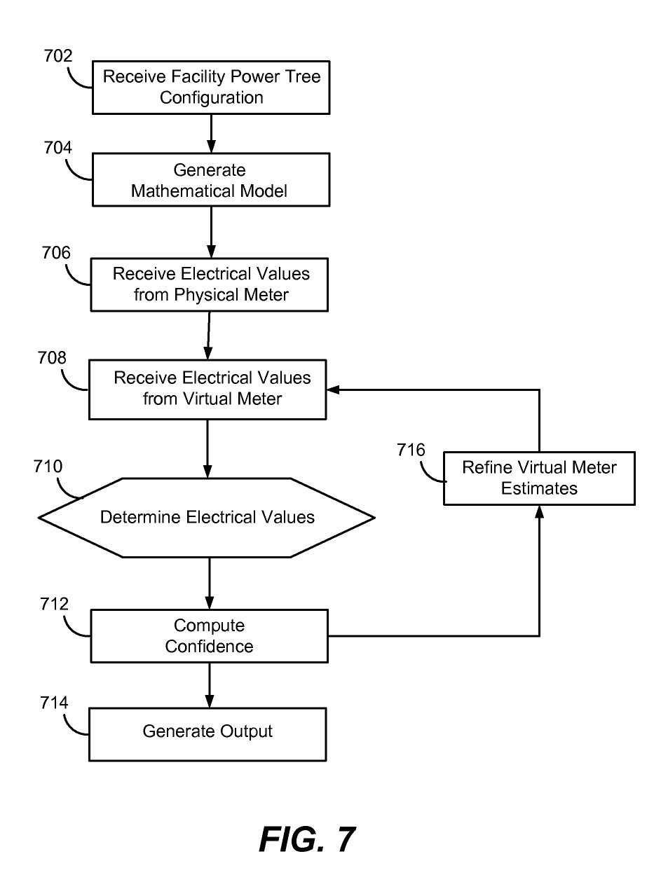

Referring now to FIG. 6, it illustrates one embodiment of a high-level block diagram of the power tree analysis module 204. As shown in FIG. 6, the power tree analysis module 204 includes several modules. Power tree input module 602 is coupled to the input of conversion module 604. Conversion module 604 and electrical value input module 606 are coupled to the input of analysis module 608. Analysis module 608 is coupled to the input of confidence module 610. Confidence module 610 is coupled to the input of refinement module 612 and output module 614. The operation of the modules can be understood by reference to the processes described in FIG. 7 below.

FIG. 7 illustrates one embodiment of a flow chart for determining electrical values from the power tree configuration of a facility. A power tree input module 602 receives 702 a power tree configuration. The power tree configuration is passed to a conversion module 604 which generates 704 a mathematical model from the power tree configuration. The mathematical model is passed to the analysis module 608. An electrical value input module 606 receives 706 708 electrical values for assets in the power tree configuration from hardware and virtual meters. The electrical values are passed to the analysis module 608. The analysis module 608 determines 710 electrical values for other assets in the power tree based on the mathematical model and the electrical values. The electrical values are passed to confidence module 610 which computes 712 confidence levels for the electrical values. If the confidence values are too low, confidence module passes control to refinement module 616 which can refine 716 the parameters of the virtual meter 202. If the confidence values are not too low, confidence module passes electrical values and confidence levels to output module 614 which generates 714 an output. Additional details are described below.

The power tree input module 602 receives 702 a power tree configuration for a facility. The power tree configuration includes information about which assets are in a facility and how the assets are connected to each other on the power distribution tree. In other words, the power tree configuration represents the configuration of assets in a facility. In one embodiment, a user can enter the information for a power tree configuration through a user interface. Using the user interface, the user can manually list each of the assets as well as the connections between the assets. In other embodiments, the power tree configuration may be received in the form of a text file, an excel spreadsheet, a visual graph as in FIG. 5, etc. The power tree configuration can also be received from a variety of sources. For example, it may be entered by a user, loaded from a database, downloaded from another computer over a network, etc.

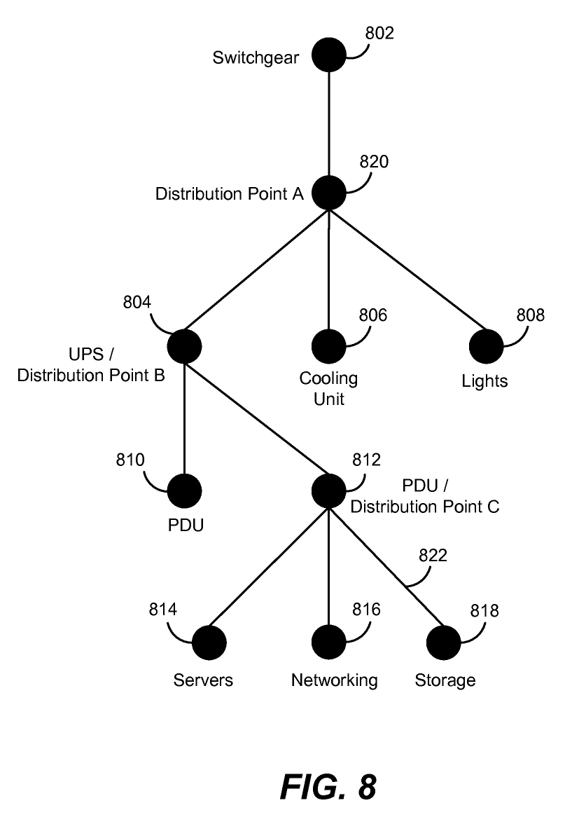

The conversion module 604 generates a mathematical model 704 based on the power tree configuration. The model reflects the relationships within the power tree configuration, such as the connections between one asset and another asset, or the connections between an asset and a distribution point. For ease of understanding, the model can be visualized as a series of nodes and edges connecting those nodes. FIG. 8 is one embodiment of a mathematical model which is based on FIG. 5. A node can represent a distribution point, an asset, or both. For example, UPS 804 is both an asset and a distribution point. A node may consume electricity, produce electricity, or do neither. For example, servers 814, networking 816, and storage 818 consume power. Switchgear 802 produces power. Distribution point A 820 neither consumes nor produces power. The nodes are connected by edges, each edge representing an electrical connection between two separate nodes. For example, edge 822 represents an electrical connection between PDU 812 and Storage 818.

The electrical value input module 606 receives electrical values. In one embodiment, the electrical values are received from both a physical meter and a virtual meter 202 as described herein. In another embodiment, the electrical values are received solely from a physical meter. In another embodiment, the electrical values are received solely from a virtual meter 202 as described herein. The physical and virtual meters are each configured to measure the electrical values of an asset. The physical meter may be integrated into an asset or may be a device which is separate from the asset. Further, the received electrical values may be associated with the node in the mathematical model which corresponds to the asset for which the electrical values were measured.

The analysis module 608 determines electrical values for assets in the power tree from the configuration of the power tree. In one embodiment, the module infers electrical values based on the received electrical values and the mathematical model. As described above, the system assumes that electricity entering one node is equal to the electricity leaving that node. Further, it should be noted that if a node is both an asset and a distribution point, then the electricity consumed by the node can also be accounted for. In sum, electrical values for nodes in the mathematical model are inferred from the following formula:

Ein=Eout+Econsumed

Ein represents the electricity entering a node from an upstream node. Eout represents the electricity leaving a node and entering downstream nodes. Econsumed represents the electricity consumed by the node.

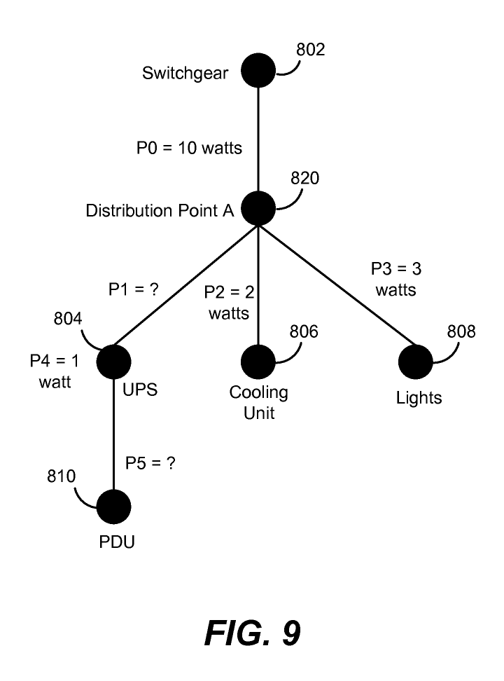

For example, FIG. 9 illustrates a mathematical model with both known and unknown electrical values. The analysis module 608 infers the unknown values from the known values. P0, P1, P2, and P3 represent the electricity entering Distribution point A 820, UPS 804, Cooling Unit 806, and Lights 808 respectively. The values for P0, P2, and P2, are already known. P0 is equal to 10 Watts, P2 is equal to 2 Watts, and P3 is equal to 3 Watts. It is assumed that distribution point A does not consume any electricity. Based on the above formula, the analysis module 608 determines that that P0=P1+P2+P3. Given that P0, P2, and P3 are known, the analysis module solves for P1. As a result, P1+P0−P2−P3=10−2−3=5 Watts.

Further, once the analysis module 608 determines one set of electrical values, those determined electrical values can be used to determine another set of electrical values. Continuing with the same example from FIG. 9, P4 represents the electricity consumed by UPS 804. P5 represents the electricity entering PDU 810. As determined above, P1 is equal to 5 Watts. P4 is known to be 1 Watt. Based on the above formula, the analysis module 608 determines that P1=P4+P5. Given that P1 and P4 are known values, the analysis module 608 solves for P5. As a result, P5=P1−P4=5−1=4 Watts.

Following this process, the analysis module 608 can determine electrical values for every asset in the power tree. In one embodiment, if not enough information is available for the analysis module 608 to determine the electrical values of a node, the analysis module can fill in the blanks by making assumptions about the electrical consumption of a node. One assumption is that electrical consumption is divided evenly among nodes that have unknown electrical values. For example, referring to FIG. 9, assume that P0 and P2 are known values, but P1 and P3 are unknown values. Given that both P1 and P3 are unknown, it is not possible to calculate their values with precision. However, the analysis module 608 can assume that P1 and P3 consume equal amounts of electricity. Thus, based on the above formula, it can be estimated that P1 and P3 each consume 4 Watts of electricity.

The confidence module 610 determines a confidence level 712 for the electrical values in the power tree. The confidence level is an indication of the level of certainty associated with an electrical value. The maximum confidence is given when electrical value is precisely determined without any possible error. Confidence can be expressed as a percentage, where 0% represents the lowest level of confidence and 100% represents the maximum level of confidence. Confidence may also be expressed as an error, where a 100% confidence is equivalent to a 0% error, and a 0% confidence is equivalent to a 100% error. The error may be computed using a relative error equation derivation.

The level of confidence associated with an electrical value may depend on the source of the measurement. Measurements received from some physical hardware meters have a high level of confidence due to the construction of the meter. Electrical values determined by the virtual meter 202 and the analysis module 608 may have a lower level of confidence due to the uncertain nature of these measurements.

Confidence module 610 also determines whether the confidence level for an electrical value is too low. In one embodiment, if the confidence is too low, the refinement module 612 refines 716 the virtual meter estimates. For example, the virtual meter 202 may determine with low confidence that an asset consumes 120 Watts of electricity. This causes the power tree analyzer to determine with low confidence that an upstream asset, a PDU, consumes −20 Watts of electricity. However, the power tree estimate cannot be correct because a PDU is a low-loss asset which consumes, not generates, electricity. Thus, the refinement module 612 adjusts the power model in the virtual meter 202 so that the virtual meter output is closer to 100 watts, which in turn allows the power tree analyzer to return a more sensible 0 Watt reading for the PDU. Then analysis module 608 infers new electrical values for the power tree 710 using updated electrical values from the virtual meter.

The output module 614 generates 714 an output. In one embodiment, the output includes the received, estimated, and inferred electrical values for the entire power tree. The output also includes the confidence levels associated with each electrical value. In another embodiment the output values are displayed to the user. To assist the user in understanding the power consumption of the facility, the electrical values and confidence values for the assets are displayed in a manner that facilitates understanding of the data, such as in a report, bar graph, line graph, pie chart, etc. Alternatively, the output can be stored into a computer-readable medium for later use.

In a further embodiment, the system receives, estimates, and infers electrical values continuously. The system records the electrical value results as time series data where each electrical value is associated with a timestamp. From this data, the system can find the minimum, maximum, and nominal electrical quantities consumed at or produced by every asset and distribution point in the facility. The system can also update the power tree and mathematical model as assets are added or removed to the facility. Further, the error associated with the virtual meter estimates can be reduced by successive iterations of the process. With each pass of the process, more information is collected from the power tree analysis module 204 which can be used to refine the estimates of the virtual meter. Several numerical analysis methods, such as the gradient descent, can be used to converge the error to 0%. Alternatively, error can be estimated using a linear stochastic estimator or a Kalman filter. Estimated error can be minimized through derivation of the estimator, with the error approaching 0% at quadratic speed when using a gradient descent algorithm.

In one embodiment, the system infers electrical values and confidence levels for every asset in the power tree. In an alternate embodiment, the system infers electrical values for only a select portion of the power tree.

As illustrated by the preceding discussion, the power tree analysis module 204 determines electrical values for assets in a power tree based on the electrical values associated with other assets in the power tree. The disclosed embodiments beneficially allow for measuring electrical consumption of assets in a facility without the need for installing physical meters on every asset in the facility. When used in conjunction with the virtual meter 202, the need for physical meters is even further reduced.

ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as described with FIGS. 2, 3, 4, 5, 6, and 7. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for estimating and inferring the electrical consumption of a facility through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer implemented method of determining electrical values of assets in a facility, comprising:
receiving a power tree configuration of the facility, the facility configured with a plurality of assets that are connected by a power distribution tree;
generating a mathematical model from the power tree configuration, the model comprising a plurality of nodes representing the plurality of assets;
receiving electrical values from a first meter;
associating the electrical values from the first meter with a first node of the plurality of nodes;
receiving electrical values from a second meter;
associating the electrical values from the second meter with a second node of the plurality of nodes;
determining electrical values for a third node of the plurality of nodes based at least in part on the electrical values associated with the first and second nodes.

2. The method of claim 1, wherein the first meter is a virtual meter, the virtual meter configured to determine electrical values based at least in part on dynamic and static information associated with an asset of the plurality of assets, the dynamic information representing at least one of the work done by or utilization of the asset, and the static information identifying at least one of the asset, components of the asset, or properties associated with the asset.

3. The method of claim 2, wherein the virtual meter is further configured to select a power consumption model based on the static information and to determine electrical values based in part on the power consumption model.

4. The method of 1, wherein the first meter is a physical hardware meter that is configured to measure the electrical values of an asset of the plurality of assets.

5. The method of claim 1, where the assets are pieces of electrical equipment.

6. The method of claim 1, wherein the mathematical model reflects relationships between the plurality of assets in the power tree configuration, the model further comprising a plurality of connections between the nodes representing electrical connections, and wherein the plurality of nodes either consume or produce power.

7. The method of claim 1, wherein the first node is upstream of the second and third nodes, and the electrical values for the third node are determined in part by subtracting the electrical values associated with the second node from the electrical values associated with the first node.

8. The method of claim 2, further comprising determining a confidence level for each of the electrical values.

9. The method of claim 8, further comprising refining the electrical values determined by the virtual meter responsive to determining the confidence level.

10. The method of claim 1, further comprising outputting the electrical values to a display.

11. A computer system for determining the electrical values of assets in a facility, comprising:
a power tree input module configured to receive a power tree configuration of the facility, the facility configured with a plurality of assets that are connected by a power distribution tree;
a conversion module configured to generate a mathematical model from the power tree configuration, the model comprising a plurality of nodes representing the plurality of assets;
an electrical value input module configured to:
receive electrical values from a first meter;
associate the electrical values from the first meter with a first node of the mathematical model;
receive electrical values from a second meter; and
associate the electrical values from the second meter with a second node of the mathematical model; and
an analysis module configured to determine electrical values for a third node of the mathematical model based at least in part on the electrical values associated with the first and second nodes.

12. The system of claim 11, wherein the first meter is a virtual meter, the virtual meter configured to determine electrical values based at least in part on dynamic and static information associated with an asset of the plurality of assets, the dynamic information representing at least one of the work done by or utilization of the asset, and the static information identifying at least one of the asset, components of the asset, or properties associated with the asset.

13. A computer readable storage medium storing instructions, the instructions when executed by a processor cause the processor to:
receive a power tree configuration of the facility, the facility configured with a plurality of assets that are connected by a power distribution tree;
generate a mathematical model from the power tree configuration, the model comprising a plurality of nodes representing the plurality of assets;
receive electrical values from a first meter;
associate the electrical values from the first meter with a first node of the plurality of nodes;
receive electrical values from a second meter;
associate the electrical values from the second meter with a second node of the plurality of nodes;
determine electrical values for a third node of the plurality of nodes based at least in part on the electrical values associated with the first and second nodes.

14. The computer readable medium of claim C1, wherein the first meter is a virtual meter, the virtual meter configured to determine electrical values based at least in part on dynamic and static information associated with an asset of the plurality of assets, the dynamic information representing at least one of the work done by or utilization of the asset, and the static information identifying at least one of the asset, components of the asset, or properties associated with the asset.

15. A computer-implemented method for determining electrical values, comprising:
receiving dynamic information for an asset, the dynamic information representing at least one of the work done by or the utilization of the asset;
receiving static information for the asset, the static information identifying at least one of the asset, components of the asset, or electrical properties of the asset;
automatically selecting a power consumption model from a plurality of models responsive to and based on the received static information;
determining electrical values for the asset based on the dynamic information and the power consumption model.

16. The method of claim 15, wherein the dynamic information is transmitted by the asset.

17. The method of claim 15, wherein the static information is transmitted by the asset.

18. The method of claim 15, wherein at least one of the plurality of power consumption models is the power consumption model for a heating unit, cooling unit, appliance, television, networking equipment, or storage equipment.

19. The method of claim 15, wherein the dynamic information is received from network and system management software (NMS) installed on the asset.

20. The method of claim 15, further comprising computing a confidence value for the electrical values.
